(19) United States
(12) Patent Application Publication
(10) Pub. No.: US 2024/0075695 A1
(43) Pub. Date: Mar. 7, 2024

(54) APPARATUS FOR FORMING TUBULAR SHAPE ADHESIVE TAPE

(71) Applicants: David Edwards Lancaster, Soddy Daisy, TN (US); Caelan D Whitfield, Soddy Daisy, TN (US)

(72) Inventors: David Edwards Lancaster, Soddy Daisy, TN (US); Caelan D Whitfield, Soddy Daisy, TN (US)

(21) Appl. No.: 18/446,079

(22) Filed: Aug. 8, 2023

Related U.S. Application Data
(60) Provisional application No. 63/402,139, filed on Aug. 30, 2022.

(51) Int. Cl. B29C 65/50; B31F 7/00; B65H 35/00

(52) U.S. Cl. CPC B29C 65/5007; B31F 7/004; B65H 35/0026; B65H 2301/45; B65H 2701/377

(57) ABSTRACT

An apparatus and method for forming a tubular masking tape from a planar masking tape easily and quickly. The apparatus includes an elongated frame having a proximal end and a distal end. A tape head is coupled over the distal end. A tape roll of the planar masking tape can be mounted to the tape head. A roller ASSY is spatially positioned above the top side of the frame, wherein the roller ASSY includes an upper roller and a lower roller positioned one above another. A die is mounted over the top side of the frame spatially between the tape head and the roller ASSY. A leading edge from the tape roll is passed through a slot in the die and thereafter the curved leading edge from the slot is pressed between the rollers of the roller assy.

### CROSS-REFERENCE TO RELATED APPLICATIONS

This application claims priority from a U.S. Provisional Patent Application Ser. No. 63/402,139 filed on Aug. 30, 2022, the disclosure of which is incorporated herein by reference in their entirety.

### FIELD OF INVENTION

The present invention relates to an apparatus for dispensing tubular adhesive tape, and more particularly, the present invention relates to an apparatus for transforming a planar adhesive tape into a tubular adhesive tape.

### BACKGROUND

Masking tapes, also popularly known as painter's tape, are well-known in the art for a variety of purposes. Primarily, masking tapes are used in paint works to mask an area. The masking tapes generally have a pressure-sensitive adhesive layer that can be easily peeled off without leaving any residue. Masking tapes are planar and long strips available in the form of rolls. While painting, masking tape can be applied around the surface to be painted such that to mask off the area surrounding the surface to be painted preventing the paint to seep into surrounding areas. The edge of the masking tape defines a demarcation line between the painted surface and the unpainted surface resulting in a paint line. However, such paint lines can often appear unaesthetic due to the abrupt transition between the painted surface and the unpainted surface, referred to as a hard paint edge.

The above problem of hard paint edge is often prominent while painting discontinuous surfaces, such as in automotive body painting. In automotive body painting there are various masking techniques employed to blend and mask the paint around discontinuous body features like door jams, trunk gaps, and other areas where a soft paint edge is desired. Hard lines from poor priming technique, bad masking, and the like are detrimental to the finish required. Painters have developed a technique of using a formed tape to mask a perimeter around a section of the panel to be painted, wherein the formed tape allows for forming a soft paint edge. In forming the masking tape, an edge along the length of the masking tape is rolled transversely over the non-adhesive side of the masking tape such that the adhesive side is exposed. The curve formed by the rolled edge faces the area to be painted and allows for forming a soft edge. This forming of the masking tape requires hand skills and is a labor-intensive and time-consuming process. Cylindrical foams are also available that can be applied directly as masking tape; however, such cylindrical foams are costly. Such cylindrical foams are not widely available. Moreover, to reduce cost, short sections of automotive masking tape (typically 12″ or less) are rolled by hand to form an adhesive tube to be pressed into door jams and other sections. This method works well and is inexpensive, however, it is time-consuming and labor-intensive. Moreover, while forming, the adhesive side is contaminated.

Thus, a need is appreciated for an apparatus for forming a tubular masking tape from a roll of ordinary planar masking tape.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for easily and quickly forming a tubular masking tape from a roll of plain masking tape.

It is another object of the present invention that no skills or expertise may be needed for forming the tubular masking tape from a tape roll.

It is still another object of the present invention that sections of any length can be formed.

It is yet another object of the present invention that the contamination of the masking tape roll and the formed tubular masking tape can be prevented.

It is a further object of the present invention that the apparatus is compact and portable.

It is still a further object of the present invention that the apparatus is economical to manufacture.

In one aspect, disclosed is an apparatus for forming a tubular masking tape from a planar masking tape, the apparatus comprising an elongated frame having a proximal end and a distal end, a tape head coupled over the distal end and configured to mount a tape roll of the planar masking tape; a roller ASSY spatially positioned above a top side of the frame, the roller ASSY comprises an upper roller and a lower roller positioned one above another; and a die, the die mounted over the top side of frame spatially between the tape head and the roller ASSY. The apparatus further comprises a clamp for mounting the apparatus to a supporting structure. The apparatus further comprises a blade unit coupled to the proximal end of the frame. The tape head comprises a pair of prongs rotatably mounted to the frame, wherein the tape roll is mounted over the two prongs, the two prongs, the die, and the roller ASSY are so positioned such that a leading edge of the planar masking tape from the tape roll passes straight through the die and the roller ASSY. The apparatus further comprises a pair of plates that extends upwards from a left side and a right side of the frame near the proximal end of the frame, the upper roller and the lower roller are mounted to the pair of plates. The die comprises a slot through which the leading edge of the planar masking tape passes through, the slot has a horizontal leg and an angled leg. The horizontal leg is broader than the angled leg. An end of the horizontal leg is made rounded and broader, and broader than the horizontal leg.

In one aspect disclosed is a method for forming a tubular masking tape from a planar masking tape, the method comprises providing an apparatus comprises an elongated frame having a proximal end and a distal end, a tape head coupled over the distal end and configured to mount a tape roll of the planar masking tape, a roller ASSY spatially positioned above a top side of the frame, the roller ASSY comprises an upper roller and a lower roller positioned one above another, and a die, the die mounted over the top side of frame spatially between the tape head and the roller ASSY. The method further comprises forming the tubular masking tape from the planar masking tape.

In one aspect, the die comprises a slot through which the leading edge of the planar masking tape passes through, the slot has a horizontal leg and an angled leg, wherein the method further comprises inserting a leading edge of the planar masking tape into the slot of the die; adhering an adhesive side of an edge portion along a length of a leading edge portion coming out from the slot to a plane side of an opposite edge portion to form a tubular tape portion; and passing the tubular tape portion through between the upper roller and the lower roller, wherein the upper roller and lower roller compresses the tubular tape portion.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of the apparatus, according to an exemplary embodiment of the present invention.

FIG. 2 is another perspective view of the apparatus, according to an exemplary embodiment of the present invention.

FIG. 3 is a side view of the apparatus, according to an exemplary embodiment of the present invention.

FIG. 4 shows a tape roll mounted to a tape head of the apparatus and a leading edge of the tape from the tape roll, according to an exemplary embodiment of the present invention.

FIG. 5 shows another perspective view of the apparatus with the tape roll shown in FIG. 4, according to an exemplary embodiment of the present invention.

FIG. 6 is a side view of the apparatus with tape roll shown in FIG. 4, according to an exemplary embodiment of the present invention.

FIG. 7 is an enlarged front view of a die of the apparatus, according to an exemplary embodiment of the present invention.

FIG. 8 is an exploded view of the apparatus, according to an exemplary embodiment of the present invention.

FIG. 9 illustrates forming a tubular tape roll from a tape roll using the apparatus, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is an apparatus for forming a tubular masking tape from a roll of plane masking tape, also referred to herein as tape roll. The tubular masking tape can be applied to mask off an area defining a demarcation line between a painted surface and an unpainted surface. The demarcation line results in a desirable soft paint edge. The disclosed apparatus allows for forming a tubular masking tape from a masking tape roll in an easy, reliable, efficient, and economical manner. The user can form any length section of tubular masking tape from the disclosed apparatus.

The planar masking tape can be any ordinary masking tape commercially available that has a plane side and an opposite adhesive side. The masking tape can be made from suitable paper or any other material known to a skilled person for making the masking tape. Any such material for the masking tape is within the scope of the present invention. The paper has an adhesive layer that forms the adhesive side of the masking tape. The adhesive layer can be made from pressure-sensitive adhesive, or any other adhesive known to a skilled person for use in masking tapes, and any such adhesive layer is within the scope of the present invention. Masking tape of any width can be used with the disclosed apparatus, wherein the apparatus can be customized for different width masking tapes. The disclosed apparatus allows rolling the planar masking tape into a tubular masking tape in which an edge portion of the masking tape, either left edge or right edge, is curved inwards, along the length of the masking tape, at the plane side thereof exposing the adhesive side, and the tape, along its length, is further curved in the same direction so that the adhesive side of the curved edge portion overlaps the opposite edge portion on the plane side thereof, and the curved edge portion stick to the plane surface of the opposite edge portion forming the tubular masking tape. The adhesive side of the edge portion overlaps with the opposite plain side of the edge portion to form the tubular masking tape.

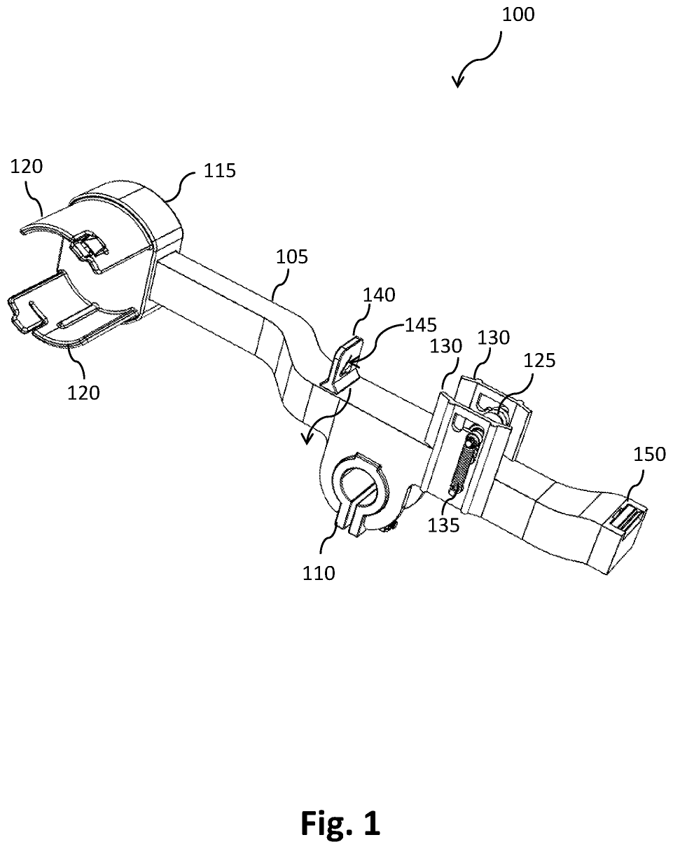

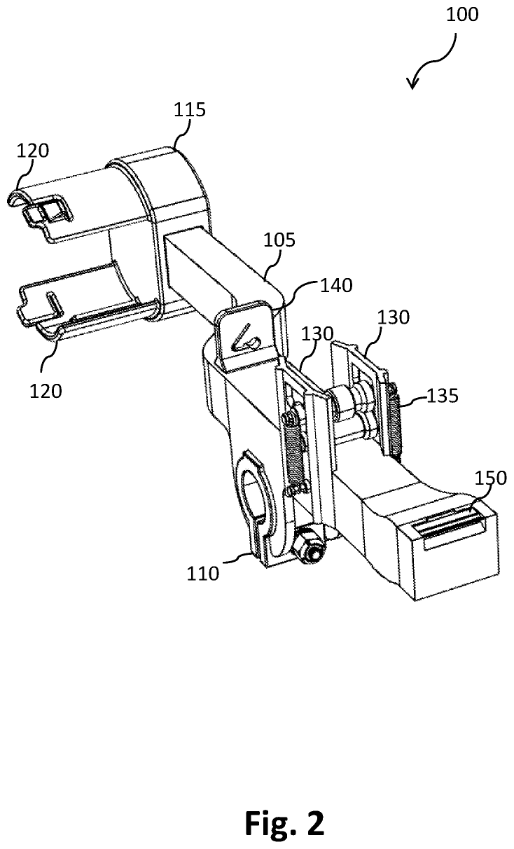

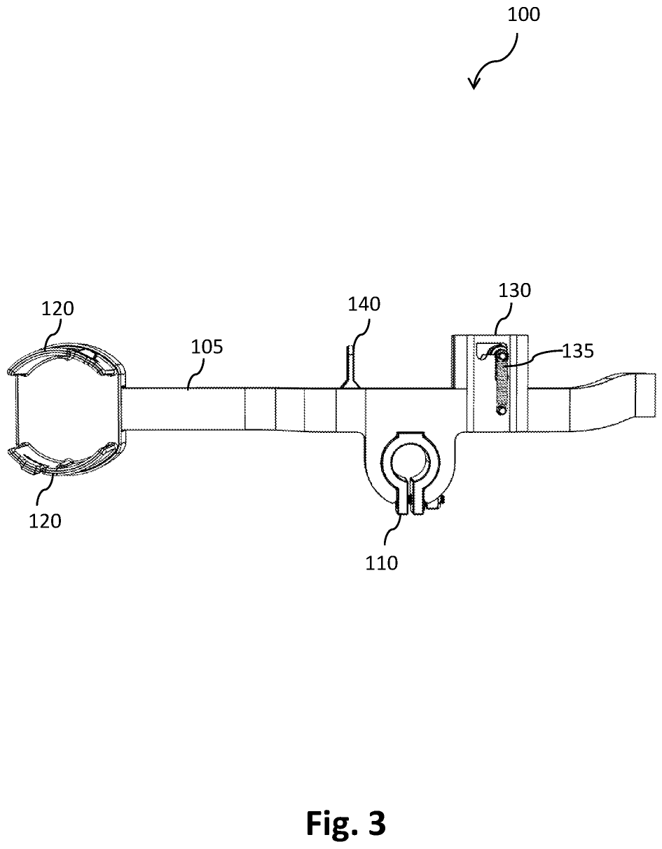

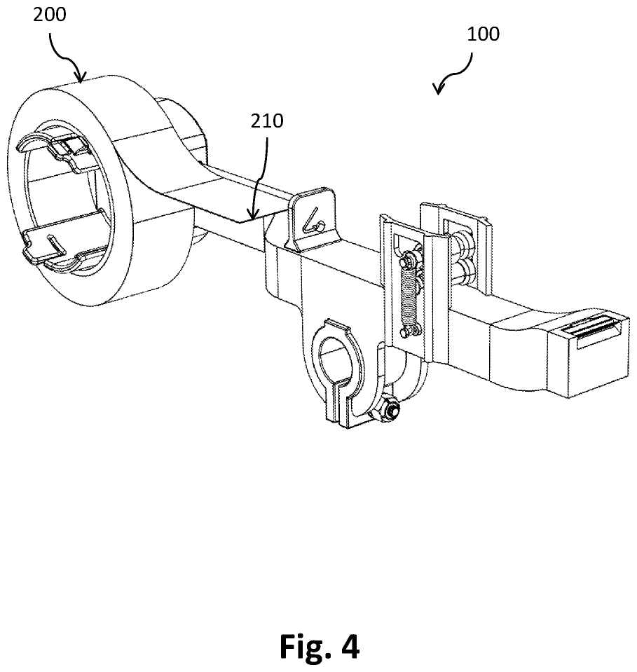

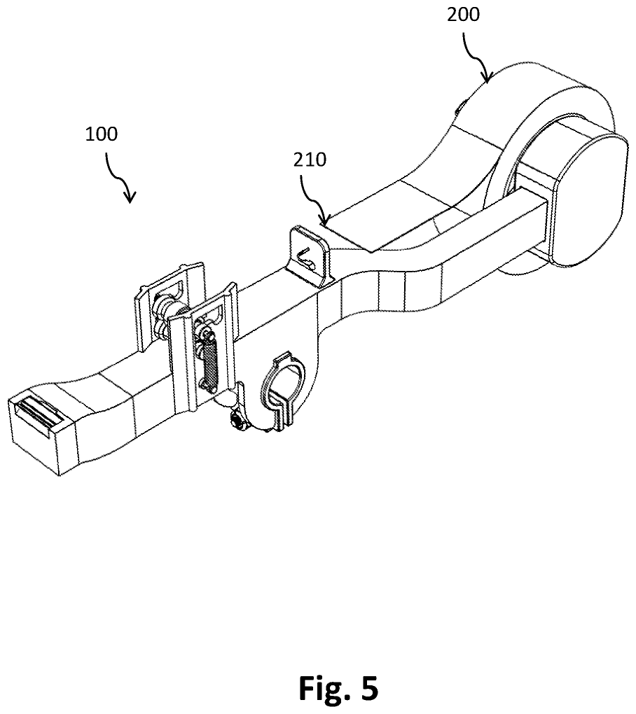

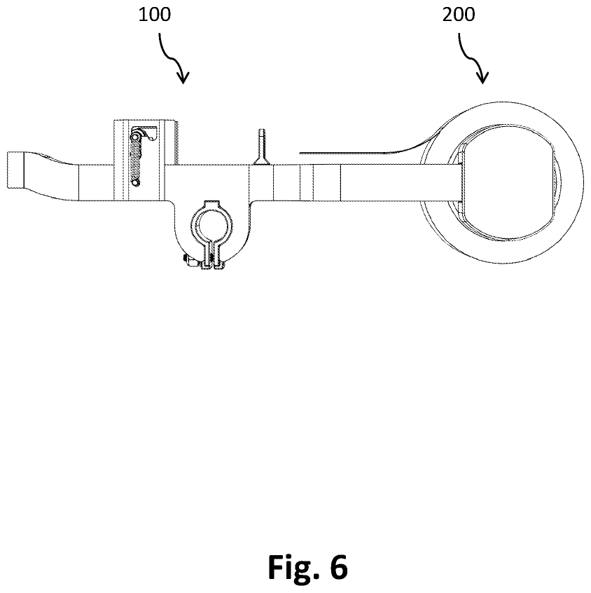

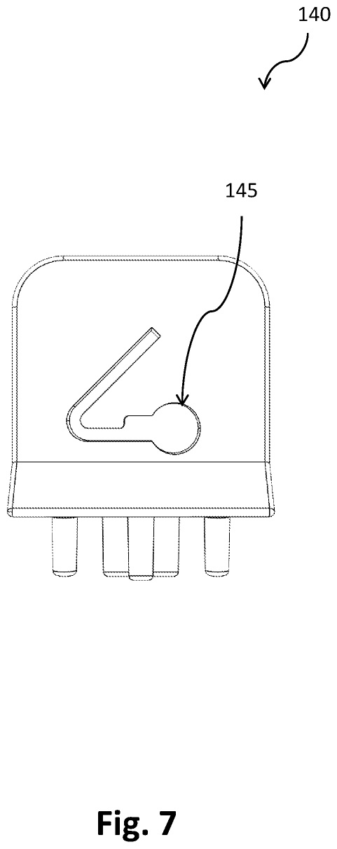

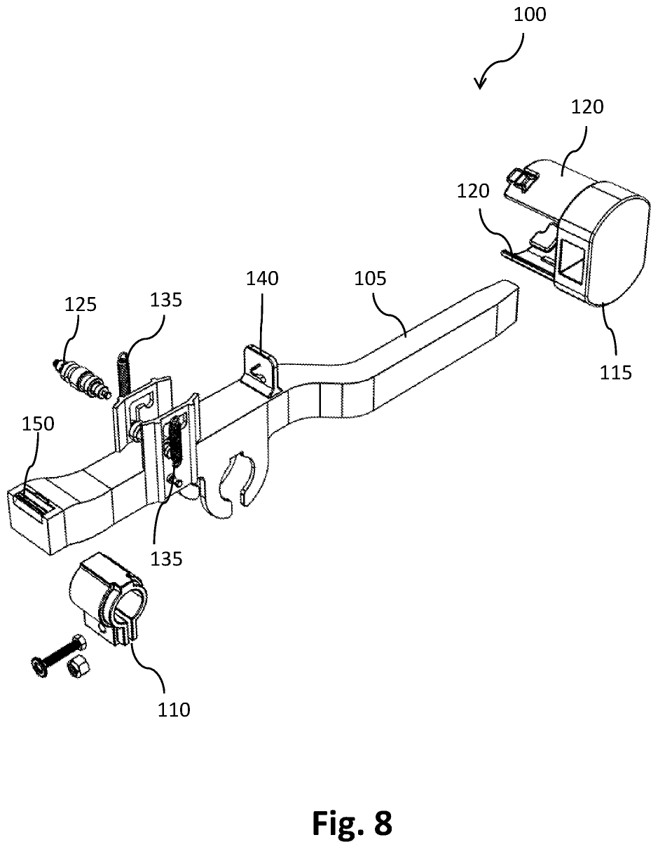

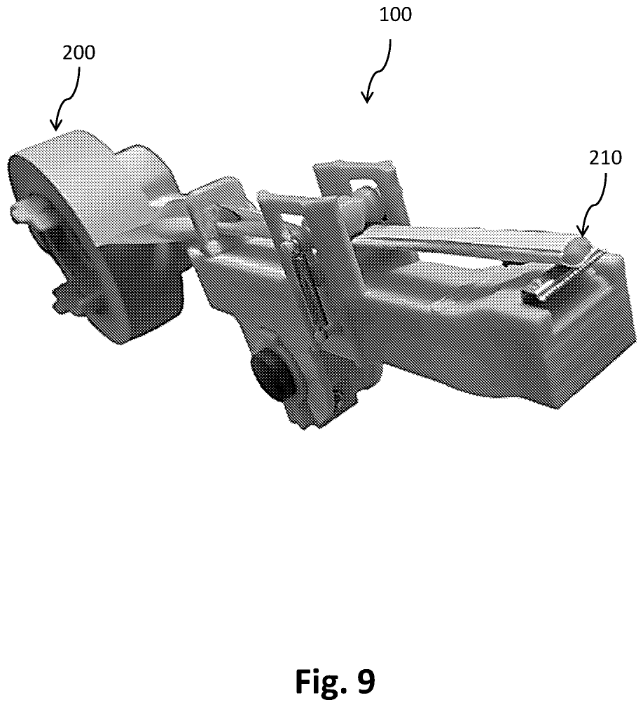

Referring to FIGS. 1-3 which show different views of disclosed apparatus 100. FIGS. 3-6 show the apparatus with the tape roll shown mounted to a tape head and a leading edge of the tape shown extended towards a die of the apparatus. FIG. 7 shows a front view of the die and FIG. 8 shows an exploded view of the apparatus. FIG. 9 illustrates the forming of tubular tape from the tape roll.

Referring to FIG. 1 which shows a perspective of an implementation of the disclosed apparatus. The apparatus 100 includes an elongated frame 105 that has a proximal end and a distal end. The frame has a top side, a bottom side, a left side, and a right side. The frame can be mounted to a stand for supporting the disclosed apparatus over a surface. Such a stand can be a part of the disclosed apparatus or can be separable from the frame. FIG. 1 shows a mounting clamp 110 to mount the frame over the stand. It is understood, however, that the mounting clamp can be used to mount the disclosed apparatus to any suitable supporting structure, and thus the stand may be optional. Moreover, instead of the mounting clamp, any fastening mechanism can be incorporated to mount the disclosed apparatus to a supporting structure, such as mounting brackets, suction cups, magnets, and the like. Any such fastening mechanism for mounting the disclosed apparatus to a supporting structure is within the scope of the present invention. The supporting structure can be a stand, tabletop, wall, and the like. The fastening mechanism can be provided on the bottom side, left side, or right side of the frame. FIG. 1 shows the mounting clamp 110 on the bottom side of frame 105.

To the distal end of the frame 105 is shown a tape head 115 over which a masking tape roll 200 can be mounted. The tape head includes a wheel encased within the tape head and two prongs 120 can extend from the wheel. The masking tape roll 200 can be mounted to the two prongs 120. The wheel and thus the tape roll can rotate to dispense the masking tape, wherein some resistance to the rotation of the wheel can be made so that some tension can be maintained in the dispensed masking tape. The amount of tension can be adjusted, such as by using a tensioner member that can frictionally resist the rotation of the wheel. The wheel can be rotatably mounted to the distal end of the frame. It is to be noted that any other mechanism for mounting the tape roll and dispensing the masking tape from the tape roll is within the scope of the present invention. For example, the two prongs can be stationary, and the tape roll can rotate over the two prongs.

Near the proximal end of the frame is shown a roller ASSY 125 spatially positioned above the top side of the frame 105. The roller ASSY includes two cylindrical rollers mounted one above another, wherein the distance between the two rollers can be increased or decreased. Two supporting plates 130 extend upwards from the left side and the right side respectively of the frame, and the two rollers are mounted to the two supporting plates. The rollers can rotate in either direction i.e., clockwise or counterclockwise. Moreover, the two rollers can rotate independently from each other. In certain implementations, the upper roller can be configured to rotate in only one of the two directions and the lower roller can be made to rotate only in a direction opposite to that of the upper wheel. Tension between the two rollers can be maintained using a pair of springs 135.

The apparatus further includes a die 140 positioned over the top side of the frame and in between the roller ASSY and the tape head. The die 140 includes a slot 145 of a shape as shown in FIG. 7, through which the leading edge 210 of the tape from the tape roll can pass through. The shape of the slot is unique that allows for the rolling of the tape as it passes through the slot.

As shown in FIG. 7, the slot is substantially of a V-shape with one end of the slot rounded. The slot has a horizontal leg and an angled leg. The end of the horizontal leg is broad with a rounded end. The rounded end is broader than the horizontal leg which allows rolling of the planar tape.

The leading edge 210 of the tape 200 from the roller mounted to the wheel can be made to pass through the die 140 and then sandwiched between the two rollers of the roller ASSY. Some tension can be maintained within the tape between the roller ASSY and the tape roll. The shape of the slot in the die is important for the forming of tubular tape from the planar tape. The slot has a horizontal leg and an angled leg. An end of the horizontal leg can have an orifice that is slightly wider to allow for the initial orientation of one of the adhesive tape edges to be flipped 180 degrees. The shape of the slot allows for first curving the edge portion through the orifice and then further curving the tape to form the tubular tape. FIG. 9 illustrates the process in which the leading edge of the tape can be seen rolled to the tubular shape and also the shape of the tape passing through the slot of the die is shown.

The distal end of the frame can be provided with a blade 150 to cut the tubular masking tape up to the desired length; however, such a blade can be optional.

In operation, the roll of planar tape can be mounted over the prongs of the apparatus. Thereafter the leading edge can be made to pass through the die of the apparatus. The leading edge of the planar tape passing through the die gets curved as shown in FIG. 9. The curved leading edge can be manually formed into the tubular shape by adhering the curved edge portion to the plane side of the opposite edge portion, and the formed tubular tape end can be sandwiched between the two rollers while maintaining slight tension in the tape. The shape of the rollers (having a groove on one side) as shown in the drawings allows for selectively compressing the tape seam without creasing the tubular tape edges. Now the tubular leading edge of the tape coming out through the two rollers can be pulled out to form the tubular tape section. The tubular tape section up to the desired length can be cut and used. It is understood that the positions of the wheel, the die, and the roller ASSY can be optimized relative to each other for forming the tubular adhesive masking tape as shown in the drawings.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for forming a tubular masking tape from a planar masking tape, the apparatus comprising:
a frame of an elongated profile having a proximal end and a distal end, a tape head coupled over the distal end and configured to mount a tape roll of the planar masking tape;
a roller ASSY spatially positioned above a top side of the frame, the roller ASSY comprises an upper roller and a lower roller positioned one above another; and
a die, the die mounted over the top side of frame spatially between the tape head and the roller ASSY.

2. The apparatus for claim 1, wherein the apparatus further comprises:
a clamp for mounting the apparatus to a supporting structure.

3. The apparatus according to claim 1, wherein the apparatus further comprises:
a blade unit coupled to the proximal end of the frame.

4. The apparatus according to claim 1, wherein the tape head comprises a pair of prongs, wherein the tape roll is mounted over the pair of prongs, the pair of prongs, the die, and the roller ASSY are so positioned such that a leading edge of the planar masking tape from the tape roll passes straight through the die and the roller ASSY.

5. The apparatus according to claim 1, wherein the apparatus further comprises:
a pair of plates that extends upwards from a left side and a right side of the frame near the proximal end of the frame, the upper roller and the lower roller are mounted to the pair of plates.

6. The apparatus according to claim 1, wherein the die comprises:
a slot through which a leading edge of the planar masking tape passes through, the slot has a horizontal leg and an angled leg.

7. The apparatus according to claim 6, wherein the horizontal leg is broader than the angled leg.

8. The apparatus according to claim 7, wherein an end of the horizontal leg is made rounded and broader and broader than the horizontal leg.

9. A method for forming a tubular masking tape from a planar masking tape, the method comprises:
providing an apparatus comprises:
a frame of an elongated profile having a proximal end and a distal end, a tape head coupled over the distal end and configured to mount a tape roll of the planar masking tape,
a roller ASSY spatially positioned above a top side of the frame, the roller ASSY comprises an upper roller and a lower roller positioned one above another, and
a die, the die mounted over the top side of frame spatially between the tape head and the roller ASSY; and
forming the tubular masking tape from the planar masking tape.

10. The method for claim 9, wherein the apparatus further comprises:
a clamp for mounting the apparatus to a supporting structure.

11. The method according to claim 9, wherein the apparatus further comprises:
a blade unit coupled to the proximal end of the frame.

12. The method according to claim 9, wherein the tape head comprises a pair of prongs rotatably mounted to the frame, wherein the tape roll is mounted over the pair of prongs, the pair of prongs, the die, and the roller ASSY are so positioned such that a leading edge of the planar masking tape from the tape roll passes straight through the die and the roller ASSY.

13. The method according to claim 9, wherein the apparatus further comprises:
a pair of plates that extends upwards from a left side and a right side of the frame near the proximal end of the frame, the upper roller and the lower roller are mounted to the pair of plates.

14. The method according to claim 9, wherein the die comprises a slot through which a leading edge of the planar masking tape passes through, the slot has a horizontal leg and an angled leg, wherein the method further comprises:
inserting a leading edge of the planar masking tape into the slot of the die;
adhering an adhesive side of an edge portion along a length of a leading edge portion coming out from the slot to a plane side of an opposite edge portion to form a tubular tape portion; and
passing the tubular tape portion through between the upper roller and the lower roller, wherein the upper roller and lower roller compresses the tubular tape portion.

15. The method according to claim 14, wherein the horizontal leg is broader than the angled leg.

16. The method according to claim 15, wherein an end of the horizontal leg is made rounded and broader, and broader than the horizontal leg.
